(19) United States
(12) Patent Application Publication
(10) Pub. No.: US 2008/0256443 A1
(43) Pub. Date: Oct. 16, 2008

(54) SYSTEM FOR AGGREGATING AND DISPLAYING SYNDICATED NEWS FEEDS

(75) Inventors: Wencheng Li, Santa Clara, CA (US); Chi-Hung Andrew Choi, San Francisco, CA (US); Virginie De Bel Air, San Francisco, CA (US)

Correspondence Address: THORNE & HALAJIAN;APPLIED TECHNOLOGY CENTER, 111 WEST MAIN STREET, BAY SHORE, NY, 11706, US

(73) Assignee: FRANCE TELECOM, Paris (FR)

(21) Appl. No.: 11/735,889

(22) Filed: Apr. 16, 2007

(51) Int. Cl. G06F 3/00

(52) U.S. Cl. 715/700

(57) ABSTRACT

The invention relates to a system for aggregating and displaying syndicated news feeds, said system comprising a graphical user interface comprising at least a first and a second user spaces, a tag generator engine to generate relevant tags from the incoming content of each syndicated news feed, a processor operatively coupled to the graphical user interface and the tag generator engine for displaying on the first user space representations of the relevant tags as a function of said tags occurrences, said representations adapted to be dragged and dropped onto the second user space, said processor being further arranged to display in the second user space the content associated to a tag when its representation is dropped into said second user space.

### FIELD OF THE PRESENT SYSTEM

The present invention generally relates to computer systems and more specifically to performing operations using drag and drop features.

### BACKGROUND OF THE PRESENT SYSTEM

There is an explosion of digital content both user-created and professional available. With this explosion comes the need to channel and filter the ever increasing content load to avoid an overflow. Another rising need is the sharing of information. A user may want to share content he/she found with people he/she knows (peer recommendation) or simply share his/her experiences, through e.g. blogs, RSS feeds or podcasts.

RSS, which can stand for Really Simple Syndication, Rich Site Summary or RDF Site Summary, is a type of web feed formats allowing to broadcast content that is frequently updated, such as blogs, news feeds or podcasts.

The RSS content or file, also called syndication, is specified in XML (extensible Marked up language) language. The information is delivered through a RSS feed, stream or channel, or webfeed. The RSS feed can be used in other sites to display its content or in client software called aggregator. An aggregator allows to retrieve and visualize in a webpage the syndicated content from one or more RSS feeds the user has subscribed to. To do so, the user may supply to the aggregator a link to the feed he/she is interested into. The aggregator allows a regular check of the user's subscribed RSS feeds to see if any of these feeds have new content, i.e. have been updated, since the last check, and if so, retrieves the new content and presents it to the user through an interface such as a graphical user interface (GUI).

Aggregators are an interesting tool to save time and simplify the need for a regularly check of websites updates, through a unique user interface regrouping all the RSS feed content. Once a feed has been subscribed to, an aggregator will handle the check and retrieval of new content periodically. Thus, any update of an RSS feed may be pushed to the aggregator. An aggregator may also search for (i.e. pull) any available updates for the RSS feeds the aggregator user has subscribed to. The moment the user is not longer interested in the content of a feed, he may easily unsubscribe so that its content is not longer retrieved.

Aggregators have been developed by most major internet actors such as Yahoo and Google. Other popular online aggregators such as netvibes.com, Blogdex, Day-pop, Feedster, . . . are commonly used to display news content in a friendly and readable way.

The content of different RSS feeds may be displayed on the graphical user interface in different content blocks or windows (e.g. one per feed, or one regrouping a selection of one or more feeds content, . . . ) that can be updated as more content is coming in from the different subscribed feeds.

With the ever growing flow of news, a user may still have difficulties sorting out the information retrieved by the aggregator he uses. Search tools have been developed to select the content displayed in order to limit the displayed news to the user fields of interest.

In existing aggregators, the searches and queries a user may formulate remain nevertheless limited in flexibility and are for most not user friendly. Furthermore the sharing of interesting feeds, news, videos, . . . is not facilitated.

More generally, to facilitate the searching of information and data, tagging has been introduced. A content may be associated with a number of keywords that characterize said content. The keywords may be automatically generated by tag engines when the content allows their use. The tagging may also be user generated, e.g. for pictures and videos. Flickr™ is a good example of the use of togs attached to pictures. Tagging allows to retrieve content by searching for all content sharing the same keywords.

Nevertheless, tagging, while facilitating a search, is not necessarily user friendly, and offers limited sharing capabilities.

There is still a need today for a user friendly search tool that allows the user to easily search content from multiple origins, whether it comes from multiple RSS feeds he has subscribed to, web sites offering content, his/her own libraries of content. There is a further need for such a tool that can be accessed in a matter of a few inputs from the user, like a few clicks of the mouse or a few touches of a touch screen with a stylus, thus allowing the user to visualize the results of his/her search easily and in no time.

### SUMMARY OF THE PRESENT SYSTEM

It is an object of the present system to overcome disadvantages and/or make improvements in the prior art.

To that extend, the present invention proposes a system for aggregating and displaying content from syndicated news feeds, said content comprising a plurality of items, said system comprising:

a graphical user interface comprising at least a first and a second user spaces,

a tag extractor engine to extract from each item tags characterizing said item,

a storage medium to store each item with the tags characterizing it,

a processor operatively coupled to the graphical user interface and the storage database for displaying on the first user space virtual representations of the tags as a function of said tags occurrences, said virtual representations being adapted to be dragged and dropped into the second user space,

said processor being further arranged to select first items comprising a first tag from the storage medium and display said selected first items in the second user space when the virtual representation of said first tag is dragged and dropped into said second user space.

The system according to the invention allows a user to regroup in a personalized webpage all the syndicated news content he is interested to, whether it is RSS feed content displayed in different blocks, or search blocks to display all content having one or more tags in common.

In an accordance with an additional embodiment of the present invention, the processor is further arranged to select second items comprising both the first tag and a second tog from the storage medium, and display said second selected items in the second user space, when the virtual representation of said second tag is dragged and dropped onto the first content in said second user space.

In an accordance with a further embodiment of the present invention, the processor selects the second items by searching the first items comprising the second tag.

In an alternative embodiment of the system according to the invention, the first items and the second items are displayed in a window in said second space.

In an accordance with an additional embodiment of the present invention, each item is characterized by a meta data, and wherein the tag extractor engine uses the meta data to extract the tags from an item.

The invention also relates to a method for aggregating and displaying content from syndicated news feeds on a graphical user interface comprising at least a first and a second user spaces, said content comprising a plurality of items, said method comprising the acts of:

extracting from each item tags characterizing said item,

storing in a storage medium each item with the tags characterizing it,

displaying on the first user space virtual representations of the tags as a function of said tags occurrences, said virtual representations being adapted to be dragged and dropped into the second user space,

selecting first items comprising a first tag from the storage medium and displaying said selected first items in the second user space when the virtual representation of said first tog is dragged and dropped into said second user space.

### BRIEF DESCRIPTION OF THE DRAWINGS

The present system is explained in further detail, and by way of example, with reference to the accompanying drawings wherein:

FIG. 1 shows an exemplary embodiment of the system according to the invention,

FIG. 2 shows an detailed exemplary embodiment of the system according to the invention,

FIG. 3 shows a flow chart illustrating how the tags are extracted and displayed on the user space in the method according to the invention,

FIG. 4 shows a flow chart illustrating how the tags are dragged and dropped onto the user space in the method according to the invention,

FIG. 5A to 5C shows how a virtual representation of a tag may be dragged and dropped into the second user space, causing the display in a search block of the items comprising said tag,

FIG. 5D shows how a virtual representation of a second tag may be dragged and dropped into the previous search block for displaying a refined search with items comprising both tags,

FIG. 6 shows a flow chart illustrating how content items may be shared with a recipient in the method according to the invention, and,

FIG. 7 shows an exemplary embodiment of the method according to the invention, with the sharing of the search results performed on a tag with a recipient.

### DETAILED DESCRIPTION OF THE PREFERRED EMBODIMENTS

The following are descriptions of exemplary embodiments that when taken in conjunction with the drawings will demonstrate the above noted features and advantages, and introduce further ones.

In the following description, for purposes of explanation rather than limitation, specific details are set forth such as architecture, interfaces, techniques, etc., for illustration. However, it will be apparent to those of ordinary skill in the art that other embodiments that depart from these details would still be understood to be within the scope of the appended claims.

For example, the invention allows an easy search and sharing of items from a content library and is described here after in its application to an aggregator service, to visualize information from several RSS feed contents. The described embodiment relates to a web site and server which implements the aggregator service. In this exemplary embodiment, the items from the content library correspond to the items received from the different RSS feeds.

The man skilled in the art will notice that this is not the sole embodiment possible, and that the system and method according to the invention may be implemented on a user device (or client device) such as a personal computer, a PDA, a phone, or the likes. The content may also be data files such as music, pictures, videos, . . . either stored locally on a user's device or remotely accessible, content that have been tagged beforehand either manually or automatically when possible. The invention may also be applied in the context of a content library that comprises both web related material (e.g. from RSS feeds) and data files (music, videos, pictures, . . . ).

Unless specified otherwise, the exemplary embodiment will be described hereafter in the context of an RSS feed aggregator.

Moreover, for the purpose of clarity, detailed descriptions of well-known devices, systems, and methods are omitted so as not to obscure the description of the present system. In addition, it should be expressly understood that the drawings are included for illustrative purposes and do not represent the scope of the present system.

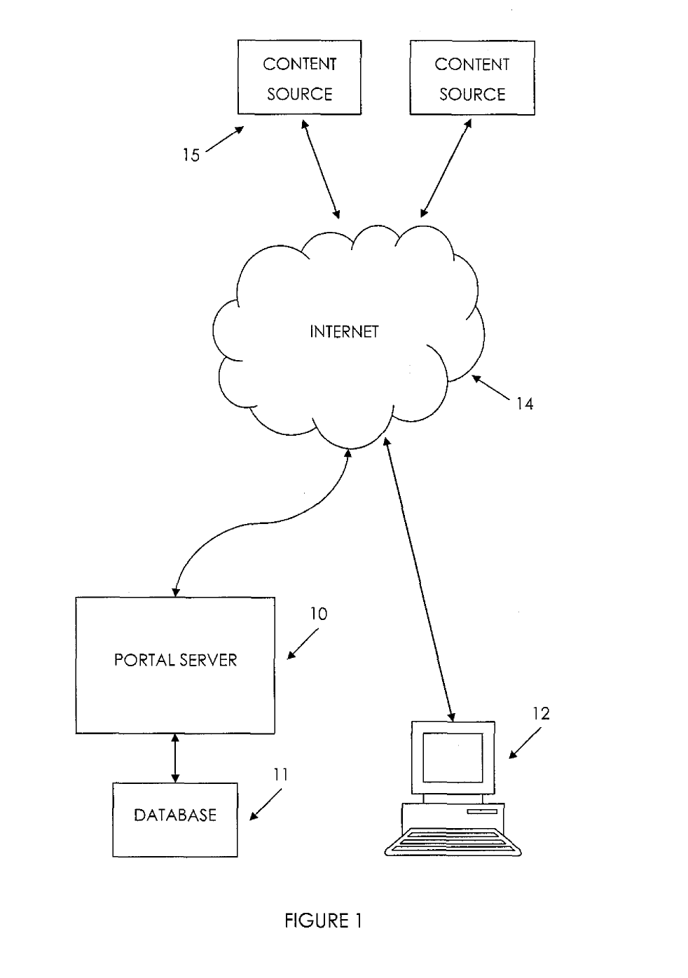

FIG. 1 is an illustration of a information network that may be used to implement the system according to the invention. A network 14, for example the internet, is connected via a relevant exchange protocol to a portal server 10 hosting the aggregator application according to the invention. The portal server 10 has access to different content sources 15 (e.g. web sites) thanks to the network 14. One or more client devices 12 may access the content sources 15 directly or the portal server 10 through network 14. Other client devices 12 may access the portal server 10 through additional LAN (local area networks—not shown) and network 14.

Portal server 10 is a server used to host the RSS feed aggregator according to one exemplary embodiment of the invention. A database 11 may be provided along portal server 10 to store the RSS feed content sent to said server. In an alternative embodiment of the system according to the invention, only the address of the received items may be stored to limit the amount of stored information. By address, one may understand the logical or virtual address of the item on the network 14. This may correspond for example to the IP address of the item.

Content sources 15 may for example be data feeds as described earlier which include audio, text, videos, pictures and the like type of content. The content of a data feed may be organized in distinct items, an item being for example a piece of news, a group of pictures, the title of a document and the link to retrieve said document, . . . For each item of content, the data feed may include meta data, e.g. summary of information like an abstract, a title, name of the authors, the initial source, and one or more URL links to a corresponding underlying content. The meta data, including when available the underlying content, may be used to generate tags that characterize, i.e. relevant of, the item content, as explained later on.

The content sources may also be regular websites that do not currently offer RSS feeds. An headline and content scraper may be used to convert the content of such sources into a RSS feed format. Other sources may include, but not limited to personal content from SMS operators, local desktop applications or web services.

Client devices 12 can be of different known types, i.e. any of a personal computer, workstation, laptop, personal digital assistant (PDA), cell phone, or any other electronic device capable of accessing network 14. Client device 12 includes a browsing program, like e.g. a known browser such as Microsoft's Internet Explorer™, Netscape™, Mozilla™, or other programs adapted to electronic devices such as a cellular phone or a PDA. The browser program allows the device to access, and display the information (text, images, videos or else) from portal server 10 and content sources 15.

Client device 12 may include a plurality of user interface devices like a keyboard, mouse, touch screen, stylus or the like, for interacting with the GUI of device 12 and hence interact with text, images, and other information shown on the displayed content, such as a web page from content source 15.

Client device 12 may include one or more processors or CPU (central processing unit) to run application softwares to communicate, process and display data content as described herein. Code for such application softwares may be C, C++, HTML, XML, Java, JavaScript, etc. or any other suitable scripting language (e.g., VBScript), or any other suitable programming language that can be executed on client device 12 or compiled to be executed on client device 12.

As client devices 12 may be of different natures from one user to the other, a browser software is used to access the human machine interface of the portal server 10, also known as a web-based user interface. Such a user interface accepts input and provide output by generating web pages which are transported via the Internet and viewed by the user in his/her GUI using a web browser program. The generated web pages may include information about their format (font size, color, . . . ), the layout of the content (position of the text, pictures, videos, . . . ), the content itself to display (text, images, videos, web links), and applications that may be executed on the client side or on the server side. For example, for some applications, no code is downloaded to the client device 12 as the needed code is executed by the server. Code already present in the client device 12 may also be executed upon display of the web page or following an input from the user.

In the hereafter description, depending on the context, GUI will either refer to the visual interface of a client device, or the layout of the information displayed to the user on said visual interface.

Newer implementations utilize Java, AJAX, Microsoft .NET, or similar technologies to provide realtime control in a separate program, thus eliminating the need to refresh a traditional HTML based web browser. Such implementations or techniques, notably AJAX (Asynchronous JavaScript and XML), allows applications such as a “drag and drop” to run in part of the GUI, with limited update of the displayed web page. As there is no longer the need to download a whole web page, the navigation is made more user friendly. The user has an increased sense of interaction with the web page.

AJAX for example allows separation between the data information to deliver to the user, the format or structure of the webpage, the style elements of the webpage (fonts, picture and text layout, . . . ) and, the functionality (i.e. the applications) of the web page.

These web development techniques also allow the system and method according to the invention to be implemented. A user, through his/her client device 12, may access the portal server 10 to create on his/her GUI a personalized webpage to aggregate all the syndicated news feeds he/she is interested in. The user may register to a news feed through portal server 10. In a general manner, portal server 10 may send webpage updates when required to the client device 12, that he/she can view with his/her browser. The client device 12 may also send request for updates to portal server 10, following user's actions for example.

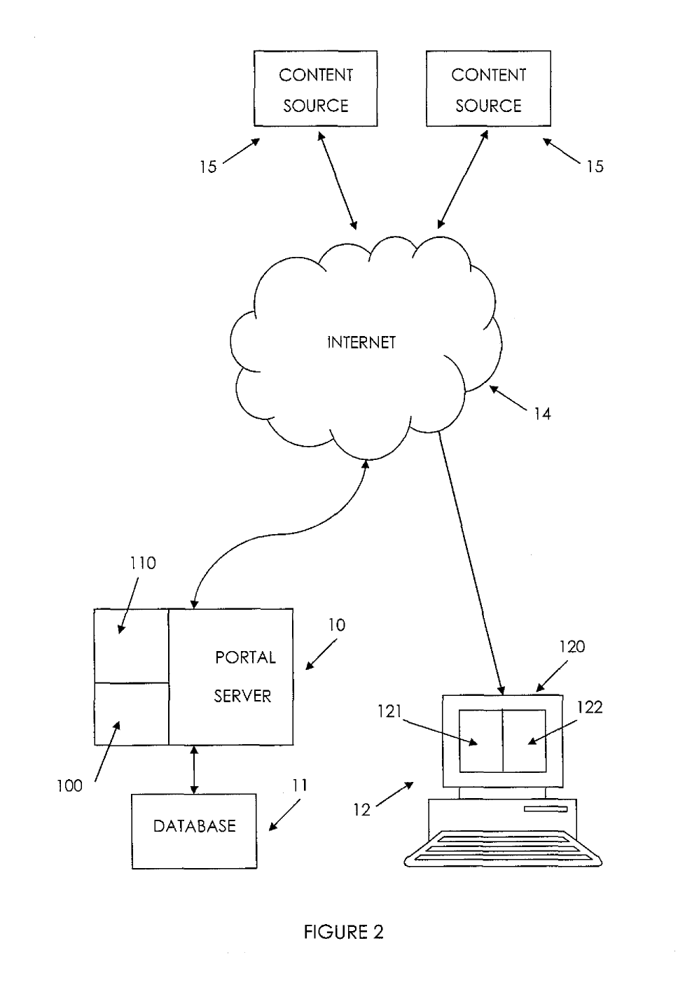

An exemplary embodiment of the system according to the invention is illustrated on FIG. 2 in the context of the aggregating and displaying of syndicated news feeds. The system comprises a GUI 120, i.e. the GUI of client device 12. GUI 120 comprises at least a first user space 121 and a second user space 122. The system further comprises an optional tag extractor engine 100, associated to server 10, in the exemplary embodiment of FIG. 2. The tag extractor engine 100 analyses the incoming content of each RSS feeds received by portal server 10 and generates relevant tags from each item of incoming content. The tag extractor engine 100 may use for each RSS feed item its meta data to extract the tags, or extract the tags over the whole item content when available. If the content is already tagged, or if the user tags his/her content (for example for pictures, music, or videos), a tag extractor engine may not be necessary.

By tag, one may understand a keyword that characterize the content item. Several tags may be available for a some item. The tags may correspond to words taken out of the content itself or the metadata of an item. The keyword may also be additional information added by a user (like e.g. when he/she characterizes a picture with one or more words), meaning that the link between the datafile and the tag is user based and does not necessarily stem from the item itself or its metadata.

Each item, along with the extracted tags, may be stored in database 11 for later retrieval. As mentioned earlier, only the item address and the related tags may be stored. Some additional information, like the meta data of each item may also be stored. This additional information may be used to display part of the item on the client device so that the user knows what the item is about.

The exemplary embodiment in FIG. 2 further comprises a processor 110, e.g. associated with portal server 10, operatively coupled to the graphical user interface 120 and the tag generator engine 100 for displaying on the first user space 121 virtual representations of the relevant tags as a function of said tags occurrences. By operatively coupled, one may understand that information is exchanged between portal processor 110 and GUI 120 through a network that may comprises for example the internet 14 and/or a LAN (local area network), or any other type of suitable network, wireless or not. Database 11, tag extractor engine 100 and portal processor 110 may be operatively coupled as part of the same portal server 10, or as separate entities linked through a network. Furthermore, portal server is illustrated as one server, but the portal may be spread over several servers cooperating together to support the method according to the invention.

Virtual representation of a tag on the first user space 121 allows the user to grasp a clear idea on the presence of the corresponding tag in the plurality of RSS feeds he/she has subscribed to. More generally.

In the system according to the invention, the virtual representations are adapted to be dragged and dropped onto the second user space 122. This may be implemented by techniques well known by the man skilled in the art. In computer GUIs, drag-and-drop is the action of (or support for) selecting a virtual object and dragging it to a different location or onto another virtual object. By doing so, different actions may be invoked, and/or different types of links may be created between the dropped object and the virtual object is dropped upon. A drag and drop action may be achieved though a mouse, a keyboard, a stylus, or any suitable device, depending on the GUI the user is working with.

New implementations such as AJAX allow to display on the first user space 121 the virtual representations for each or a plurality of the tags extracted from the incoming RSS feeds content received by the server portal, these virtual representation being movable through a drag and drop mechanism into the second user space 122. AJAX allows the displacement of the virtual representation with no update of the whole web page.

In the system according to the invention, when a virtual representation is dragged and dropped onto the second user space, the processor is arranged to produce the display into said second user space 122 of the content associated with the tag corresponding to said virtual representation. Through the drag and drop action on a selected virtual representation, the corresponding tog is retrieved, as well as the different RRS items whose content comprises said tag. The processor then sends the retrieved items through the network to the client device 12 with display instructions into the second user space 122.

In an additional embodiment of the system according to the invention, only part of the retrieved items is either sent or displayed, to limit the overload of information presented to the user. For example, for a piece of news, only the title and the first lines of the text content may be sent and displayed to the user. For pictures and videos, it might be for example thumbnails (i.e. miniature of the pictures or videos) and a title.

When the user selects one of the retrieved items displayed on his GUI, a more complete display of the item content may be presented to the user, e.g. in a popup window.

As may be readily appreciated by the person skilled in the art, content sources as websites are merely illustrative and do not limit what may encompass the method and system according to the invention. For example, as mentioned earlier, the content sources may comprise datafiles, such as music, pictures, videos and the likes that are stored locally (i.e. stored on the client device) or accessible through a network (like a LAN network or the internet).

Furthermore, when the method according to the invention is implemented in the context of a local content library, e.g. not accessed through a network, a browser may not be necessary to display information to the user on the client device GUI. Programming languages like C++ allow virtual objects displayed on screen to be movable based on a user's input (through e.g. a mouse, a stylus, . . . ). Drag and drop features may be readily available to user thanks to such languages.

A browser may nevertheless be used when the content sources are mixed. By mixed, one may understand that the content sources are both local and distant (accessed through the internet for example) and/or that their content is either datafiles (music, videos, pictures and the likes) or web related material (e.g. RSS feed items). Mixed content sources will also be referred here after as the user's content.

Whether the method according to the invention is implemented in the context of an RSS feed aggregator or not, the method comprises the act of:

displaying on the first user space virtual representations of the tags as a function of said tags occurrences, said virtual representations being adapted to be dragged and dropped into the second user space, and,

identifying first items comprising a first tag from the content library and displaying the identified first items in the second user space when the virtual representation of said first tog is dragged and dropped into said second user space.

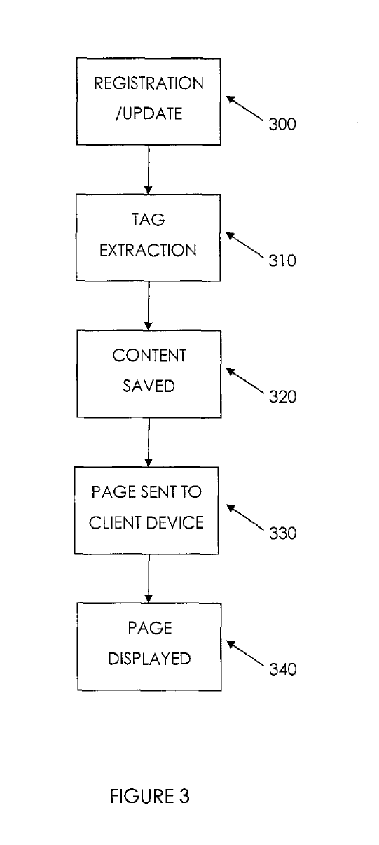

Going back to the exemplary embodiment of an RSS feed aggregator, FIG. 3 shows the different acts of a RSS feed update or registration. In a first act 300, portal server 10 receives the content from a data feed the user has subscribed to. This may be an update of the RSS feed (as the data is pushed) or the content of a newly registered feed. In this later case, act 300 is preceded by a registration act (not shown in FIG. 3) wherein the user enters an RSS feed address, for example in the form of a URL address entered through client device 12 and sent to portal server 10.

In a subsequent act 310, after the content is received, tag extractor engine 100 analyses the feed content and extracts tags that are relevant, i.e. that characterizes the feed content. When the feed content is organized in distinct items, relevant tags are extracted, i.e. generated, for each item of content. Known tag extractor engines are readily available to the man skilled in the art such as Meta-tags Extractor® from IWEBTOOL, or Extract URL® from SPADIX SOFTWARE. The tags that are provided by some RSS feeds may also be reused in the system according to the invention. Act 310 is optional when incoming items from RSS feeds are already tagged.

In an additional act 320, the RSS content is saved in the server database 11, wherein content item is saved along with the relevant tags provided by the tag extractor engine 100. Through the tagging and saving of the received RSS feed content, an indexation of the subscribed content is achieved, said indexation allowing an easy search of the saved content through the different tags used as keywords.

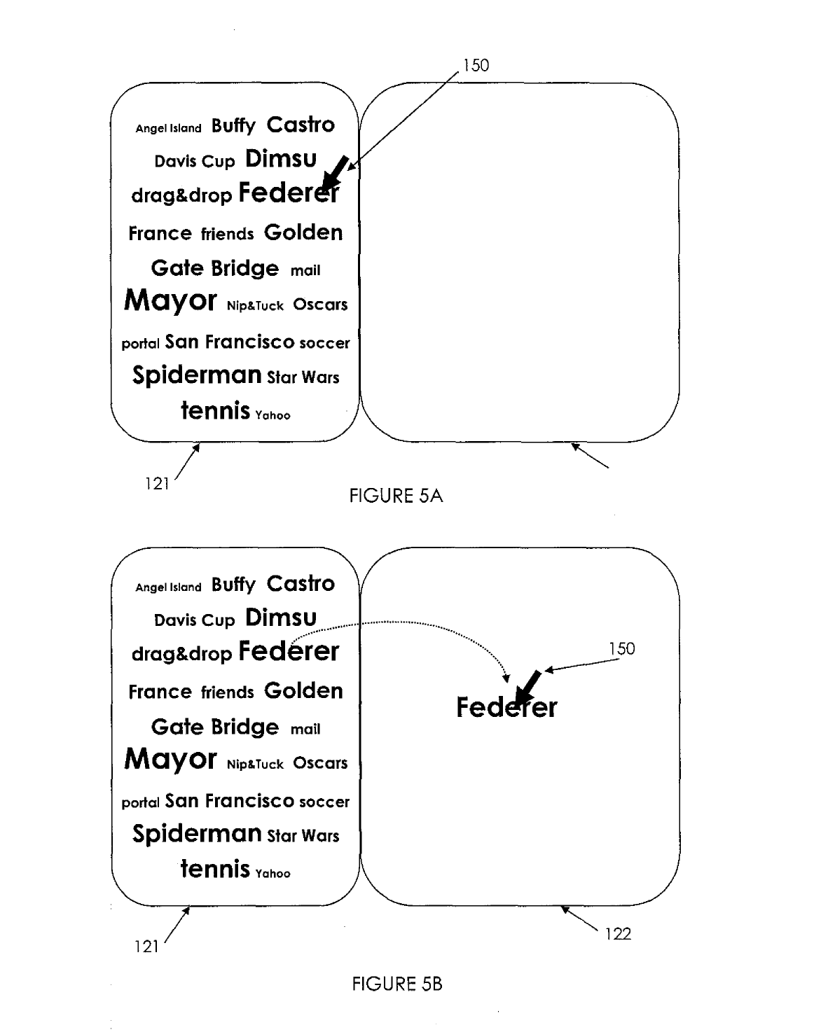

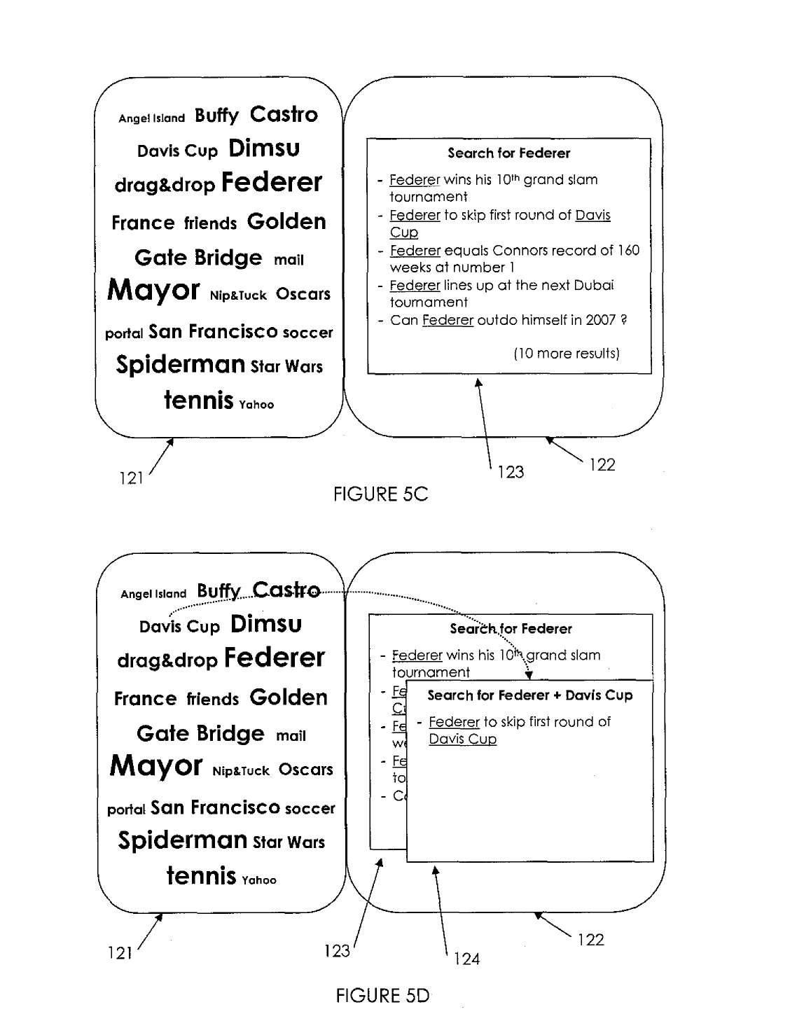

In the system according to the invention, the frequency (number of occurrences) of the tags may be tracked to measure the popularity of each tag. This datum may be used in an additional embodiment of the system according to the invention to display the virtual representations of the togs with a size and/or color function of their popularity, as illustrated in the example of FIG. 5A. In the first user space 121, an exemplary list of tags appears, with the size of the tags proportional to their respective frequency as seen at the time of display into said first user space. The popularity of a tag may be tracked from the time of subscription to a content that generated said tag (through the tag extraction engine), or based on a time frame. In the latter case, the user may chose to track the popularity of tags over a certain period of time, to take into account for example, only the most recent content.

In a further act 330, the portal server 10, through its processor 110, sends a webpage update to the client device 12 for display on its GUI 120. The updated webpage is displayed in the first user space 121, through the virtual representations linked to the tags. Each time act 320 generates new tags and/or changes the popularity of the previously available tags, the virtual representations displayed on the first user interface 121 may change in a further act 340 to show to the user that the tag list is being updated. Thanks to languages like AJAX, the update of act 340 is performed only on a portion of the displayed web page on GUI 120, i.e. limited to the virtual representations of the tags in the first user space 121.

The person skilled in the art may readily transpose the here above teachings in relation to FIG. 3 to the registration of data sources with mixed content. Registration act 300 correspond to the upload of datafiles or web related content a user may want to retrieve. As for RSS feeds, the content may be subdivided into items of content.

In subsequent step 310, the user may manually or automatically generate tags associated to these items. This step may be optional is the items are already tagged.

The content is then saved with the corresponding togs in database 11 to achieve the indexation of the items of content in act 320.

In a further step 330, a GUI (i.e. a page) is produced, said GUI comprising first and second user spaces. First user space comprises virtual representations of the tags as a function of the tags popularity. The processor of the client device may produce this GUI when the method according to the invention is implemented on said device, or a server may generate this page. As mentioned earlier a browser may be readily used to display the produced GUI. Updating may also be provided when more content is uploaded.

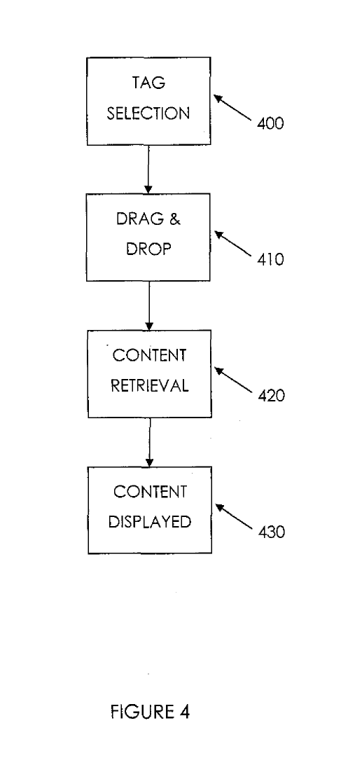

FIG. 4 described the drag and drop act of the method according to the invention. Thanks to its implementation through languages like AJAX or C++, the virtual representations of the tags are movable from the first to the second user spaces. The drag and drop act will be illustrated in its implementation through a processor, either the processor of portal server 10, or the processor of a client device when implemented on said device.

In one embodiment of the method according to the invention, a drag and drop act may be performed upon any virtual representation of a tag, as described hereafter, to cause the retrieval and display of all content items comprising said tag. If a user is interested in searching in his/her content any of the tags whose virtual representation are shown in the first user space 121, he/she may proceed as follows.

In a first act 400 of an exemplary embodiment of the method according to the invention, the user selects any one of the virtual representations as shown in FIG. 5B. The selection may be performed through cursor 150 directed by a mouse (not shown in FIG. 5B) after clicking on said mouse once cursor 150 is positioned onto the chosen representation, here “Federer” in FIG. 5B. The selected virtual representation corresponds to a first tag. Other type of selection method may be used such as touching the GUI 12 thanks to a stylus or a finger, when a touch screen is used. Any suitable selecting method may be readily used by the person skilled in the art to identify the virtual representation that is to be displaced.

In a subsequent act 410, a drag and drop is performed on this selected virtual representation. The representation is dropped onto the second user space 122. In the exemplary illustration of FIG. 5B, the virtual representation “Federer” is dragged onto the second user space 122, through a motion of cursor 150 illustrated by the dotted line. When the dropping is achieved, a message is sent to the processor that the virtual representation of the first tag has been dragged and dropped into the second user space 122. The message is generated from the user device and may be sent to the processor following any relevant communication protocol the person skilled in the art has access to.

Consequently, in a further act 420, after the first tag corresponding to the selected virtual representation is identified by the processor, the items from database 11 comprising said first tag are identified and received by the processor. If items from database 11 are stored through their address only, the processor will retrieve the identified items (or part of it) through the address. A cache memory may also be used to store the identified item content (or part of it) to facilitate their display.

In a further act 430, the GUI (i.e. the displayed page) produced by the processor is updated to comprise the identified items of act 420. The update may be limited to the second user space 122 as the first user space has already been produced during the acts in relation with FIG. 3. Second user space may be seen as a search space to retrieve the content items comprising a given tag. Once the GUI is produced it may be displayed on the client device, whether it is produced on a server site (like in the aggregator exemplary embodiment) or by the client device processor.

By displaying the items, one may understand that the processor according to the invention produces a GUI comprising said items, that are further displayed on the client device GUI.

The whole content of each item marked with the tag may be displayed. In an alternative embodiment, only part of the item content is displayed, using the whole or part of the meta data associated with this content, including e.g. a URL link, so that only a condensed information is presented to the user. Part of the content may also be used. The cache memory mentioned earlier may be readily used to limit the number of access to the sources of the items, especially if the item corresponding to the address does not evolve over time.

The identified items may be viewed thanks to the second user space 122 or part of it. In an additional embodiment of the method according to the invention, the identified items may be conveniently displayed, as shown in FIG. 5C in a content block or window 123 that opens into the second user space 122 shortly after the virtual representation is dropped. To that effect, the processor in act 430 further produce window 123 comprising the identified items. Thanks to the method according to the invention, content block 123, that can also be called a search block, comprises items of content that have the same tag, i.e. keyword, in common. A single search across all the user content is achieved. The search results are retrieved in the second user space 122, e.g. in one single search block 123. Based on the user preferences, the search may be limited to only the most recently received items, or performed over a given period of time, the possibilities depending on the nature of the user's content in database 11.

In an alternative embodiment, part of the retrieval may be anticipated by the processor according to the invention, when a virtual representation is for example dragged, i.e. before it is actually dropped onto the second user space. In this case, the presentation of the items comprising the tag are displayed almost instantaneously with the dropping of the virtual representation of said tag, as the processor generates the GUI while the dragging and dropping is performed by the user. The resulting GUI is further displayed when the user confirms his/her search by dropping the virtual representation of the tag into the second user space.

In a further embodiment of the method according to the invention, only the most up to date information may be retrieved so that the produced second user space 122 may comprise only the most recent items from the user's content. This allows to limit the storage capacity of database 11 required to store the data feed content.

A more refined search may be performed thanks to the method according to the invention. In an additional embodiment of the method according to the invention, if the user wants to retrieve content corresponding to at least two different tags, he/she may in a further act drag and drop the virtual representation of a second tag onto the content linked the first tag and already displayed in the second user space, as seen in the illustration of FIG. 5D. This drag and drop is similar to the drag and drop acts illustrated in FIG. 4, with two exceptions.

The first one being that, instead of dropping the selected virtual representation for the second tag anywhere into the second user space, it ought to be dropped onto the displayed results (i.e. the identified items) for the search on the first tag. When the content retrieved for the first tag is displayed in a content block or window 123 within the second user space 122, as illustrated in FIGS. 5C and 5D, the second virtual representation corresponding to the second tag, here “Davis Cup”, ought to be dropped into said window 123.

The second exception being that, in act 420, instead of searching and retrieving the items stored in the database 11 tagged with the second tag, only the items stored in database 11 comprising both first and second tags are identified and received by the processor according to the invention.

In an alternative embodiment of the method according to the invention, the items retrieved in database 11 comprising the first tag are stored in a buffer memory along the other tags associated with these items. When the virtual representation of a second tag is dragged and dropped, and the second tag corresponding to said virtual representation is retrieved, a search is performed on the buffer memory to select the items tagged with the second tag. The processor may then produce a GUI (or update the second user space) with the content items identified with the first and second tags.

The items attached with both tags may be conveniently displayed in a pop up window, or search block, opening on top of the identified items associated to the first tog, or be displayed in place of said identified items. FIG. 5D illustrated the results of a search on tags “Federer” and “Davis Cup”, which is displayed on the second user space 122 in an additional window 124 on top of the first window 123 with the initial search results on “Federer”. Alternatively, the first window 123 may be replaced by a search block displaying the search results for both tags, i.e. all the content items with both tags in common.

Different ways to display in the second user space 122 the results for the first tag and for both first and second tag may be readily used by the man skilled in the art and are within the scope of the present invention.

The operation may be repeated each time a user wants a more refined search on content items with two or more tags in common. Each time he/she will drag and drop a virtual representation of a tag on top of a search block, the search will be get more refined as only the content items will all tags (whose virtual representation has been dragged and dropped) are displayed.

Thanks to the system and method according to the invention, a user may display in a personal webpage all the syndicated news content he/she is interested to, whether it is RSS feed content displayed in different blocks, or search blocks to display all content having one or more tags in common. The user may also retrieve all items from his/her content that is related to one or more tags. An easy to use method to retrieve and display content items if thus achieved.

In another aspect of the method according to the invention, the drag and drop feature may be used by the user to share content with other distant devices or users.

In our world of information overload, peers recommendation is becoming a very important source of discovery of new content. However, there are no easy way to share content found within personalized webpages today. The best solution is to send the url address of the personalized webpages by email. It usually requires several acts: the opening of a email program, writing an email, attach recipient and copy and past the url a user want to share. The method according to the invention allows an easy sharing of such address by a simple drag and drop action, as described here after.

To that effect, the invention also relates to a method and processor for sharing with a recipient items available on a network through their logical address, said method comprising the act of:

selecting on a graphical user interface (GUI) a first virtual representation of one or more items to be shared, said virtual representation being associated with the items virtual address wherefrom said items to be shared can be retrieved,

dragging and dropping the selected first virtual representation in the GUI onto a second virtual representation of the distant recipient, the dropping causing a transfer of the virtual addresses of the items to be shared to the distant recipient.

An exemplary implementation of the sharing method according to the invention may be in the context of for sharing items from syndicated news feeds, as illustrated in FIG. 2. The system to implement said method may comprise:

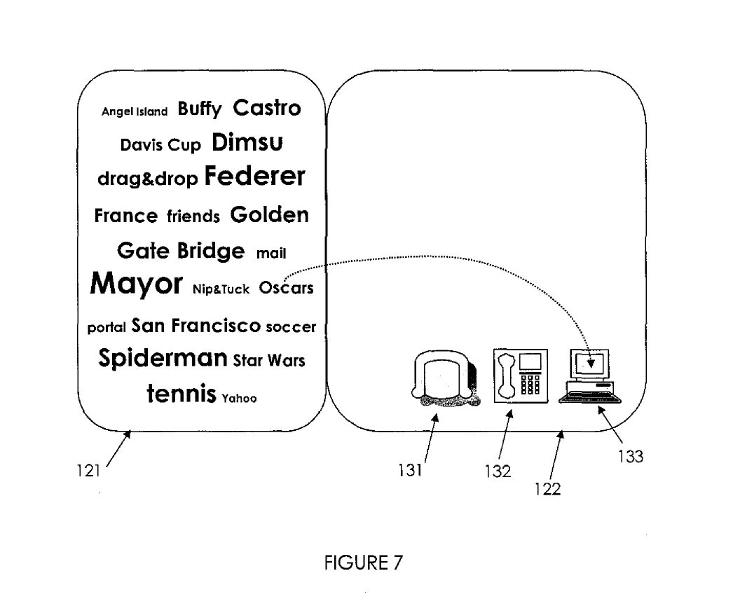

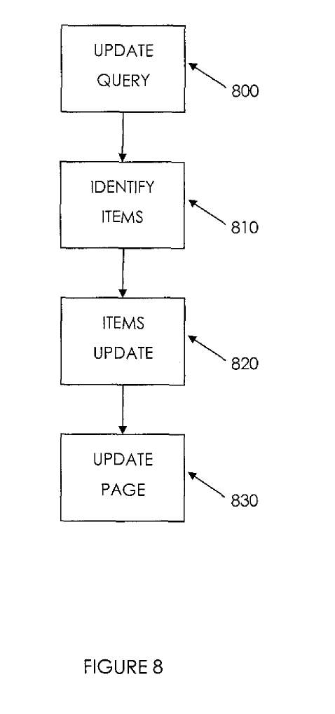

a graphical user interface 120 for displaying a first virtual representation of the items to be shared (tag “oscars” as illustrated in FIG. 7) and a second virtual representation of the recipient (avatar 133 of a distant computer in FIG. 7) of said items to be shared, the first virtual representation being adapted to be dragged and dropped in said graphical user interface,

a network 14 for retrieving items through their address,

a processor 110 operatively connected to the graphical user interface 120, said processor 110 being adapted to transfer the item address to the recipient when the first virtual representation is dragged and dropped onto the second virtual representation.

As may be readily appreciated by the person skilled in the art, the implementation in the content of RSS feeds is merely illustrative and do not limit what may encompass the method according to the invention. For example, the items to share may be datafiles, such as music, pictures, videos and the likes that are stored locally (i.e. stored on the client device) or accessible through a network (like a LAN network or the internet). The access rights are beyond the scope of this description and the items are supposed to be sharable without authorization acts.

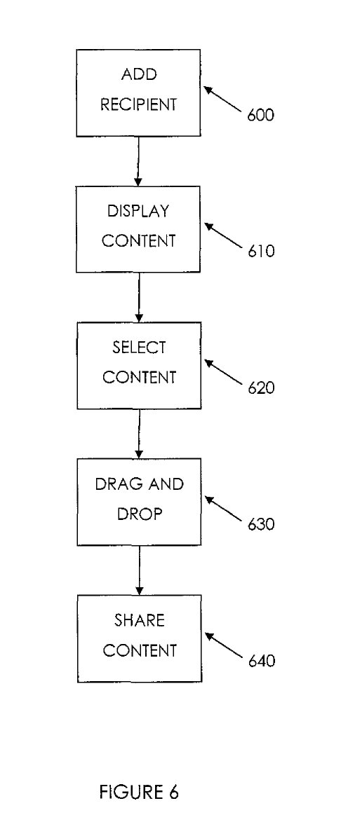

The different acts of an exemplary embodiment of the method according to the invention are described here after in relation with FIG. 6. In a first act 600 of the method, a recipient is selected and added to the list of potential recipient for the items to be shared. The recipient may be a device, such as a cell phone, a computer, a PDA, or any other client device that may receive content through a network. Such recipient may be identified by a number such as a phone number or an IP (Internet Protocol) address. The recipient may also be another user of the system according to the invention. The user then may be identified by his account information. Other way of identifying a user may comprise an email address.

Whenever a potential recipient is added, a virtual representation of said recipient is displayed on the GUI, as seen in FIG. 7. In the example of FIG. 7, three virtual representation are shown, corresponding to avatars (i.e. icons) 131, 132, and 133. Avatar 131 corresponds to another user that may correspond for example to the user's friend, or contact. Avatar 132 corresponds to a cell phone, like his/her cell phone or the phone of a friend. Avatar 133 corresponds to a distant computer, like his/her home computer when the user is presently using his/her work computer.

In a subsequent act 610, virtual representation of the items to be shared may be displayed in a graphical user interface of the user client device. The virtual representation may be a list of tags, as illustrated in FIG. 7, or RSS feed headlines as illustrated in FIG. 5C wherein the syndicated news feed items are displayed through headlines to give to the user an indication of the different items content. The RSS feed items may be retrieved through their virtual address on network 14. Thanks to new implementations like AJAX mentioned before, these virtual representations may be dragged and dropped without the need to refresh the whole webpage the user has displayed on his/her GUI.

A content library may be provided with the system according to the invention in order to store the address of the RSS feed items. The items content may be also stored on the content library if it is first downloaded by the system according to the invention before being displayed. Part of it (like headlines or meta data for said content) may only be stored on said content library.

In a further act 620 of the method according to the invention, a first virtual representation corresponding to the items to be shared is selected by the user. In a subsequent act 630, this first virtual representation is dragged and dropped onto a second virtual representation of a recipient as defined here before in relation with act 600. In the example of FIG. 7, the chosen second virtual representation corresponds to a distant computer 133.

In a further act 640 of the method according to the invention, when the first virtual representation of the items to be shared (tag “oscars” in the example of FIG. 7) is dropped onto the second virtual representation (distant computer 133 in FIG. 7), the address of the items to be shared is transferred to the recipient corresponding to the second virtual representation. Depending on the type of recipient, a different protocol transfer may be used to pass the address. For a computer or cell phone, the transfer may be through an MMS (multi media short message) or an email, or any other suitable transfer protocol for sharing the address of the items. When the recipient is another user of the system according to the invention, a message may be stored in the server 10 in association with the recipient account, so that when said recipient accesses his/her account, a visual signal may be displayed on his/her GUI in a first user space to let him/her know about the transfer. This visual signal may be advantageously dragged and dropped into a second user space to display the items corresponding to the address.

As illustrated in the exemplary embodiment of FIG. 7, the method may be applied to sharing items from syndicated feeds that have been tagged as previously described in relation with FIG. 3. The content to be shared is then a content characterized by a tag, the first virtual representation being a virtual representation of said tag.

As mentioned before, items from the different RSS feeds may be displayed in a content block on the GUI. As more content is aggregated by the user, and additionally more searches are performed, a plurality of content and search blocks may be displayed on his/her GUI each time the user access his/her personalized webpage.

Today, thanks to personalized webpages, a user may regroup and visualize items from different web or local sources into a single page to get a global view of his/her user's content. The items are actually displayed through virtual representations which correspond to icons, metadata, headlines or thumbnails depending on the type of items. Thanks to new programming languages like AJAX, the items can be updated individually, rendering them updatable. As more items are gathered in a personalized webpage by a user, whenever he/she accesses the pages or each time one of the items is updated, the user may get the perception that the system is slow and disorganized.

With the example of current RSS feed aggregators, these blocks are displayed one by one, which can cause some delay in the display of information. The user may get the impression that the display is slow and inefficient.

To that effect, the method according to the invention also relates to a method and processor for generating an update of a personalized webpage, said webpage comprising a plurality of individually updatable items, said method comprising the acts of:

receiving a unique update query, said update query comprising item information about each individually updatable item,

identifying from the unique query each updatable item comprised in the personalized webpage,

uploading an up-to-date content for each updatable item, based on its item information,

generating the update of the personalized webpage using the up to date content from each item comprised in said personalized web page.

As the update query is unique to the whole personalized page, the chore of the update is transferred to the server hosting the personalized webpage. Once the update is performed, the page is generated and send back to the end user for further display on his/her GUI.

In the context of the updating of a personalized webpage, items will refer not only to items from local or web sources, but also to the content and search blocks mentioned earlier one. Item refers to any updatable elements displayed on a personalized webpage.

A content pre-loading is done based on user's interest and action, which reflects onto the updatable items in his/her personalized webpage. Compared to traditional web applications, all the client side presentations and much more processing logic are handled by client side code. By doing so, server has less load and more output. Communication between client and server is packaged into one batch request (the unique query) at a time, which minimizes the HTTP request overhead and archives fast response.

FIG. 8 illustrates the updating method according to the invention.

In a first act 800 of the update method, the server hosting the personalized page received an unique update query. This update may be generated by the client device, either automatically or upon request from the user. The update comprises along a request for an update information about the different updatable items on the page.

In personalized webpages like aggregators, items may be search and/or content blocks. For a content block, the item information may comprise the item addresses. Several addresses may characterized the item if for example the item is a content block corresponding for example to one of more RSS feed. The item may also be a search block, like a search block described earlier. The item information may then comprise the search parameters.

In an additional act 810, the server identifies from the unique query each individually updatable items. To do so, the server breaks down the unique query.

In a subsequent act 820, the server upload, if necessary, an up-to-date content for each updatable item. If the item is a content block, the up-to-date content may be retrieve through the item address. If the item is a search block, the search is performed with the most up-to-date content the search is based upon, using the search parameters form the item information. The item information may also defined the content to be searched.

In a further act 830, the update of the personalized page is generated using the up-to-date content collected in the previous act 820.

A cache memory may be used by the server in act 820 to limit the upload act if the content has not been updated. To that effect, the server may check first for each updatable item if an update has occurred since the last update of the personalized page.

Client side caching may also be used to allow data to be reused, when no update is available for one item from the last update query. The generated page then is sent to the client device with caching instructions to reuse the item content from the previous personalized page for items that have not been updated.

The method according to the invention allows a more efficient update of the personalized webpage.

1. A processor configured to produce a graphical user interface (GUI) of items of a content library, each item being characterized by at least one tag, and said GUI comprising at least first and second user spaces, said processor comprising:
a portion configured to receive messages,
a portion configured to display on the first user space virtual representations of the tags as a function of said tags occurrences, said virtual representations being adapted to be dragged and dropped into the second user space,
a portion configured to receive identified first items related to a first tag from the content library and to display said identified first items in the second user space when said processor receives a message that the virtual representation of said first tag has been dragged and dropped into said second user space.

2. The processor of claim 1, said processor being further arranged to received identified second items related to both the first tag and a second tag from the content library, and to display said identified second items in the second user space, when said processor has received a message that the virtual representation of said second tag has been dragged and dropped onto the first content in said second user space.

3. The processor of claim 2, wherein the processor selects the second items by searching the first items comprising the second tag.

4. The processor of claim 2, wherein the first items and the second items are displayed in a window in said second space.

5. The processor or claim 1, wherein the content library comprises items from syndicated newsfeeds.

6. A method for displaying items from a content library on a graphical user interface (GUI), each item being characterized by at least one tag, and said GUI comprising at least first and second user spaces, said method comprising the acts of:
displaying on the first user space virtual representations of the tags as a function of said tags occurrences, said virtual representations being adapted to be dragged and dropped into the second user space,
identifying first items comprising a first tag from the content library, and,
displaying the identified first items in the second user space when the virtual representation of said first tag is dragged and dropped into said second user space.

7. The method of claim 6, further comprising the act of identifying second items comprising both the first tag and a second tag from the content library, and displaying said identified second items in the second user space, when the virtual representation of said second tag is dragged and dropped onto the displayed identified first items in said second user space.

8. The method of claim 7, wherein in the act of identifying second items, said second items are identified by searching the first items comprising the second tag.

9. The method of claim 7, wherein in the act of displaying the first and/or the second items, said first and second items are displayed in a window in the second space.

10. The method of claim 7, wherein the content library comprises content from syndicated news feeds, the method further comprising a preliminary act of extracting tags from each item of said content library.

11. The method of claim 8, wherein the items are characterized by meta data, the method further comprising a preliminary act of extracting the tags from at least said meta data.

12. A method for sharing with a recipient items available on a network through their logical address, said method comprising the act of:
selecting on a graphical user interface (GUI) a first virtual representation of one or more items to be shared, said virtual representation being associated with the items virtual address wherefrom said items to be shared can be retrieved,
dragging and dropping the selected first virtual representation in the GUI onto a second virtual representation of the recipient,
the dropping causing a transfer of the virtual addresses of the items to be shared to the recipient.

13. The method of claim 12, wherein the first virtual representation is a virtual representation of a tag that characterizes the items to be shared.

14. The method of claim 12, wherein the recipient is a user.

15. The method of claim 12, wherein the recipient is a distant device.

16. A processor configured to share with a recipient items available on a network through their logical address, said processor comprising:
a portion configured to received messages,
a portion configured to display on a graphical user interface (GUI) a first virtual representation of one or more items to be shared, said virtual representation being associated with the items virtual address wherefrom said items to be shared can be retrieved,
a portion configured to display on the GUI a second virtual representation of a recipient,
a portion configured to transfer the virtual address of the items to be shared to the recipient when said processor receives a message that the first virtual representation in the GUI has been dragged and dropped onto the second virtual representation.

17. The processor of claim 16, wherein the first virtual representation is a virtual representation of a tag that characterizes the items to be shared.

18. The processor of claim 16, wherein the recipient is a user.

19. The processor of claim 16, wherein the recipient is a distant device.

20-25. (canceled)

26. A processor configured to generate an update of a personalized webpage, said webpage comprising a plurality of individually updatable items, said processor comprising:
a portion configured to receive a unique update query, said update query comprising item information about each individually updatable item,
a portion configured to identify from the unique query each updatable item comprised in the personalized webpage,
a portion configured to upload for each updatable item an up-to-date content, based on its item information,
a portion configured to generate the update of the personalized webpage using the up to date content from each updatable item comprised in said personalized web page.

27. The processor of claim 26, wherein the portion to upload the up-to-date content is further configured to skip the upload for an item if said item content is identical to said item content from the previous update of the personalized webpage, said item content from the previous update being used as the up-to-date content for said item.

28. The processor of claim 26, wherein the items are items from syndicated newsfeeds.

29. The processor of claim 26, said processor being further configured to generate said personalized webpage using the Asynchronous JavaScript and XML programming language (AJAX).

30. The processor of claim 26, wherein the item information comprises a logical address.

31. The processor of claim 26, wherein the updatable item is a search result, and the item information comprises the search parameters.
